(19) United States
(12) Patent Application Publication
(10) Pub. No.: US 2009/0211322 A1
(43) Pub. Date: Aug. 27, 2009

(54) Commercial Fertilizer Product and Method of Production Thereof

(76) Inventor: Michael SKINNER, Provost (CA)

Correspondence Address: ADE & COMPANY INC., 2157 Henderson Highway, WINNIPEG, MB, R2G1P9, CA

(21) Appl. No.: 12/035,834

(22) Filed: Feb. 22, 2008

(51) Int. Cl. C05F 11/00

(52) U.S. Cl. 71/23

(57) ABSTRACT

Commercial fertilizer is produced using distillers grain or seed meal as a nitrogen component of the fertilizer and at least one additional component increasing a non-nitrogen nutrient value of the fertilizer, thereby reducing or eliminating reliance on natural gas to produce a synthetic nitrogen component for the fertilizer.

### FIELD OF THE INVENTION

This invention relates generally to commercial fertilizer and more particularly to commercial fertilizer produced without reliance on natural gas to derive a nitrogen component thereof.

### BACKGROUND OF THE INVENTION

Commercial fertilizer is often sold as premixed products, providing consumers the option of buying a ready to use product having a suitable ratio of nutrients appropriate for their particular application. This may be especially helpful in agriculture, where the farmer may not have the time or large-scale equipment needed to mix different fertilizer products, each having a higher concentration of a particular nutrient than those it will be mixed with, to tailor the end-result fertilizer to the needs of their particular crops and field conditions.

Synthesized or artificial fertilizers are primarily based on three key nutrients, namely nitrogen (N), phosphorous (P) and potassium (K), and are labeled for commercial sale according to their content of these three nutrients. Two or more component materials are mixed together, each contributing a significant majority of the amount of a particular one of these three nutrients, to produce a final blend or premix, typically a nitrogen-rich component with one or both of a phosphorous-rich component and a potassium-rich component. In these synthetic fertilizers, typically the nitrogen component is defined by or produced using ammonia synthesized using natural gas, the phosphorous component is synthesized from phosphate rock and the potassium component is potash, which may be obtained by mining and processing ore deposits. Mixing of nitrogen fertilizer to produce a premix is of course not limited to only the addition of phosphorus or potassium, as other nutrients or minerals are often desirable. For example, a relatively sulfur-rich component may be mixed with a nitrogen-rich component, with or without other non-nitrogen components raising the levels of other nutrients, to increase sulfur content of the resulting premixed fertilizer product for use with particular crops that may benefit from such sulfur content.

Recently, the price of conventional commercial fertilizer premix has increased with rising natural gas prices, effecting the production of nitrogen fertilizer. It is therefore desirable to provide commercial premixed fertilizer with a reduced dependency on natural gas.

### SUMMARY OF THE INVENTION

According to a first aspect of the invention there is provided a method of producing a commercial fertilizer product comprising the steps of producing distillers grain to define a nitrogen fertilizer component and adding at least one additional fertilizer component to the distillers grain to increase at least one non-nitrogen nutrient value of the commercial fertilizer.

Preferably the step of producing distiller's grain comprises collecting the distillers grain during production of ethanol.

The at least one additional fertilizer component may comprise a phosphorous source, a potassium source or a combination thereof. When used, the phosphorous source is preferably non-ammoniated.

According to a second aspect of the invention there is provided commercial fertilizer product comprising distillers grain and at least one additional fertilizer component increasing at least one non-nitrogen nutrient value of the commercial fertilizer.

According to a third aspect of the invention there is provided a method of producing a commercial fertilizer product comprising the steps of producing seed meal to define a nitrogen fertilizer component and adding at least one artificially produced fertilizer component to the seed meal to increase at least one non-nitrogen nutrient value of the commercial fertilizer.

Preferably the step of producing seed meal comprises collecting the seed meal during production of vegetable oil.

The at least one synthetic fertilizer component may comprise a phosphorous source, a potassium source or a combination thereof. When used, the phosphorous source is preferably non-ammoniated and may be derived from chemically treated phosphate rock.

The at least one synthetic fertilizer component may be derived from a chemical treatment process.

The seed meal may comprise soy meal or canola meal.

According to a fourth aspect of the invention there is provided a commercial fertilizer product comprising seed meal and at least one artificially produced fertilizer component increasing at least one non-nitrogen nutrient value of the commercial fertilizer.

### DETAILED DESCRIPTION

In the embodiments described herein, conventional commercial fertilizer and methods for production thereof feature replacement of the nitrogen in commercial fertilizer with distillers grain, a by-product of producing ethanol, or soy meal or canola meal, by-products created in the making of vegetable oil. The advantage of this is to take an organic renewable resource and replace the nitrogen component of the fertilizer that is typically made mostly from natural gas, which is a non renewable resource. As a result of the current drive to reduce reliance on and consumption of fossil fuels, a significant number of ethanol plants have been or are being built. As result, there is now a significant supply of distillers grain that may used as a substitute to replace the nitrogen source in conventional commercial fertilizer, resulting in a more environmentally-friendly product. Not only does the distillers grain have nitrogen in it, but it also contains smaller amounts of phosphorus and potassium, which are the other main components in commercial fertilizer. There are also trace minerals like zinc, copper and manganese in the distillers grain that normally have to be added to a commercial fertilizer by way of additional components when desired in the final product to be sold to the consumer. The term distillers grain as used herein refers to distillers dried grain (DDG) or distillers dried grain with solubles (DDGS), with ethanol plants currently tending to produce DDGS by blending and drying distillers grain and distillers solubles fractions of residue remaining after distillation of fermented mash. This use of distiller's grain, soy meal or canola meal takes such a product, originating from a crop, and puts a lot of its value back into the soil by using this product as part of the fertilizer used to grow further crops.

To produce a premix commercial fertilizer approximating desirable nitrogen, phosphorous and potassium content, or NPK values, the by-product nitrogen source provided by the distillers grain or a seed meal, such as canola or soy meal, is mixed with one or both of a relatively phosphorous-rich material and a relatively potassium-rich material by the commercial fertilizer producer/manufacturer in ratios suitable to attain an NPK rating close to that desired for subsequent sale to the consumer. In conventional synthetic commercial fertilizer, the phosphate component is obtained by processing phosphate rock to produce phosphoric acid, which is then typically further processed to produce ammonium phosphates or triple superphosphate. However, the ammonia used in production of ammonium phosphates is, like the ammonia conventionally used as the nitrogen component of synthetic fertzilizer or to produce ammonium nitrate or urea for use as the nitrogen component, relies on natural gas as a source of hydrogen. Therefore, an improved reduction in the reliance on natural gas for producing commercial fertilizer having none zero N and K values is obtained by not only using the ethanol or vegetable oil by-product nitrogen component in place of a conventional synthetic nitrogen component, but also using a non-ammoniated phosphorous source. Potash, commonly attained from mining and processing of potash ore, is typically used as the potassium source in conventional commercial fertilizer, and may be mixed with the distillers grain or seed meal from the ethanol or vegetable oil production, whether with or without a phosphorus component, to increase a K value of the fertilizer premix to be sold to the consumer.

While it is known in the art to use seed meal as a fertilizer or a component of a fertilizer premix, such use is taught in the context of organic or natural fertilizer used as an alternative to commercial fertilizer produced using synthetically produced or heavily processed components, the drive of such use typically being an attempt to reduce detrimental effects to the environment that are often associated with industrial processing and synthetic, artificial or man-made production practices. These prior art teachings thus directly oppose the mere swapping out of conventional synthetically produced nitrogen fertilizer components for canola or soy meal within a commercial grade fertilizer product that does not necessarily fall within strict confines of a natural, organic, unprocessed or low-processed fertilizer context. Thus the use of seed meal to form all or part of a nitrogen source component within a commercial fertilizer that uses artificially produced components relying on synthetic production or heavy processing to obtain or approximate desirable levels of nitrogen, phosphorous, potassium or other nutrients is not suggested in the prior art. As natural organic fertilizers tend to have lower nutrient content relative to their synthetic or heavily processed counterparts, the use of seed meal as the primary nitrogen component in an otherwise conventionally-produced commercial fertilizer premixed product lowers reliance on natural gas for production without detriment to the ratio of nutrient content to bulk within each of the other components.

It will be appreciated that additional components may be mixed into the commercial fertilizer product using distillers grain or seed meal to increase levels of nutrients other than N, P and K, for example to increase sulfur, zinc, copper or manganese levels. The use of distillers grain, soy meal or canola meal in commercial fertilizer not only reduces reliance on natural gas and price dependence thereon, but also provides a new use for the distillation by-product resulting from ethanol production or the by-product of vegetable oil production, potentially producing new inter-industry relations and benefits.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A method for production of a commercial fertilizer product comprising the steps of producing distillers grain to define a nitrogen fertilizer component and adding at least one additional fertilizer component to the distillers grain to increase at least one non-nitrogen nutrient value of the commercial fertilizer.

2. The method according to claim 1 wherein the step of producing distiller's grain comprises collecting the distillers grain during production of ethanol.

3. The method according to claim 1 wherein the at least one additional fertilizer component comprises a phosphorous source.

4. The method according to claim 1 wherein the at least one additional fertilizer component comprises a potassium source.

5. The method according to claim 1 wherein the at least one additional fertilizer component comprises phosphorous and potassium sources.

6. The method according to claim 3 wherein the at least one additional fertilizer component comprises a non-ammoniated phosphate source.

7. A commercial fertilizer product comprising distillers grain and at least one additional fertilizer component increasing at least one non-nitrogen nutrient value of the commercial fertilizer.

8. A method for production of a commercial fertilizer product comprising the steps of producing seed meal to define a nitrogen fertilizer component and adding at least one artificially produced fertilizer component to the seed meal to increase at least one non-nitrogen nutrient value of the commercial fertilizer.

9. The method according to claim 8 wherein the step of producing seed meal comprises collecting the seed meal during production of vegetable oil.

10. The method according to claim 8 wherein the at least one synthetic fertilizer component comprises a phosphorous source.

11. The method according to claim 8 wherein the at least one synthetic fertilizer component comprises a potassium source.

12. The method according to claim 8 wherein the at least one synthetic fertilizer component comprises phosphorous and potassium sources.

13. The method according to claim 10 wherein the at least one synthetic fertilizer component comprises a non-ammoniated phosphate source.

14. The method according to claim 10 wherein the phosphorous source is derived from chemically treated phosphate rock.

15. The method according to claim 8 wherein the at least one synthetic fertilizer component is derived from a chemical treatment process.

16. The method according to claim 8 wherein the seed meal comprises soy meal.

17. The method according to claim 8 wherein the seed meal comprises canola meal.
